(19) United States
(12) Patent Application Publication
(10) Pub. No.: US 2024/0091973 A1
(43) Pub. Date: Mar. 21, 2024

(54) MODULAR SYSTEM AND METHOD FOR ASSEMBLING A PACKAGING CUTTING DIE

(71) Applicant: IKARTON S.R.L., Roma (IT)

(72) Inventors: Adriano DE FRANCESCHI, Roma (IT); Marco VISANI, Roma (IT)

(21) Appl. No.: 18/302,910

(22) Filed: Apr. 19, 2023

(30) Foreign Application Priority Data
Apr. 19, 2022 (IT) 102022000007715

(51) Int. Cl. B26F 1/44; B26D 7/26; B26F 1/38

(52) U.S. Cl. CPC B26F 1/44; B26D 7/2614; B26F 1/384; B26D 2007/2607

(57) ABSTRACT

Described herein is a modular system for creating a cutting die to be used with a metal cylinder, including a set of cutting die modules each having an extension direction along an arc of a circle, a perimeter, and a connection surface in a direction perpendicular to the extension direction, which is configured to be placed on the metal cylinder, as well as a die surface opposite the connection surface and including at least one die or feeding element. The connection surface includes a module magnet extending over at least one portion from the connection surface, and each cutting die module includes shape coupling means with another module.

### CROSS-REFERENCE TO RELATED APPLICATIONS

This application claims the benefit of priority to Italian Patent Application No. 102022000007715, filed Apr. 19, 2022, the entire contents and disclosure of which are hereby incorporated by reference herein.

### BACKGROUND

The known die-cutting systems are configured to perform a die-cutting process comprising the use of the following elements:
Rotary die-cutting machine;
Perforated and threaded cutting die holder cylinder;
Cutting die.

Focusing for simplicity on a standard cardboard box 100 (FIG. 1), it is a very common model manufactured in several sizes. As seen from the figure, the box height “h” and the size of panels 1-2 (a panel means a zone delimited by folds or creases 120, dashed in the figure; all other edges 130 are obtained by cutting or pre-cutting) can be any (the size of panels 3-4 is usually the same as that of panels 1-2). Reference numeral 110 indicates the flaps of the box.

In the prior art, a whole cutting die is normally manufactured which is suitable for a specific model having a specific size (FIG. 2). If the model or the size change, there is a need to manufacture a new cutting die. In the cutting die 200 of FIG. 2, cutting and folding elements 210 and feeding elements 220 can be seen. Such elements are fixed to curved supports 230 fixed to an underlying cylinder (not shown) by means of fixing elements, such as screws.

Sometimes, again in the prior art, the packaging production only relates to very large standard cardboard boxes, and to manufacture them there is a need to halve the width thereof thus having only half of a box (FIG. 1, parts 1 and 2 only, “half standard cardboard box”) and then glue the two halves together to obtain the whole box of the desired width. In this case, the standard cutting die will be as shown in FIG. 2, manufactured in a single piece given a drawing with specific size only valid for a particular packaging to be produced (FIG. 3).

As a result, with standard cutting dies, a new cutting die should be prepared whenever the size of the same box model changes. This new cutting die will also be valid only for the size of that specific box model.

The need is felt not to have to manufacture a whole cutting die for each specific packaging to be produced.

### SUMMARY

It is an object of the present invention to provide a modular system and a method for assembling a packaging cutting die which solves the problems and overcomes the drawbacks of the prior art.

The present invention relates to a modular system and a method for assembling a packaging cutting die according to the appended claims.

### BRIEF DESCRIPTION OF THE DRAWINGS

List of FIGS.

The invention will now be described by way of non-limiting illustration, with particular reference to the figures of the accompanying drawings, in which:

FIG. 1 shows a first example of a (“standard cardboard”) box model to be manufactured with a cutting die, according to the prior art, with an indication of the cuts and folds (dashed lines);

FIG. 2 shows an example of a cutting die made in one piece, for manufacturing a box of the type shown in FIG. 1;

FIG. 3 shows an example of magnetic parts already arranged for assembling the modular cutting die according to the invention;

FIG. 4 shows the shape coupling of two elements shown in FIG. 3;

FIG. 5 shows an example of the construction of the modular cutting die according to the invention, on a metal cylinder, with elements shown in FIG. 7;

FIG. 6 shows a further example as in FIG. 5, where four rows of modular elements with different cardboard cutting and feeding elements are mounted; and

FIG. 7 diagrammatically shows (a) a top view of a module of the system according to the invention, (b) a bottom view of the same module, where a partially empty peripheral space of thickness d (distance between the edge of the module and the magnet) is shown, and (c) a lever, the ends of which can be fitted into the peripheral space to operate the lever and detach the module from the cylinder; and

FIG. 8 shows an alignment diagram of modular elements by a positioning bar according to the invention.

### DETAILED DESCRIPTION

It is specified herein that elements of different embodiments can be combined together to provide further embodiments without restrictions by respecting the technical concept of the invention, as an ordinary skilled person will effortlessly understand from the description.

Moreover, the present description also refers to the prior art for the implementation thereof, regarding the detail features not described, such as elements of minor importance usually used in the prior art in solutions of the same type, for example.

When an element is introduced, it is always understood that there can be “at least one” or “one or more”.

When a list of elements or features is given in this description, it is understood that the finding according to the invention “comprises” or alternatively “consists of” such elements.

Two or more of the parts (elements, devices, systems) described below can be freely associated and considered as part kits according to the invention.

### EMBODIMENTS

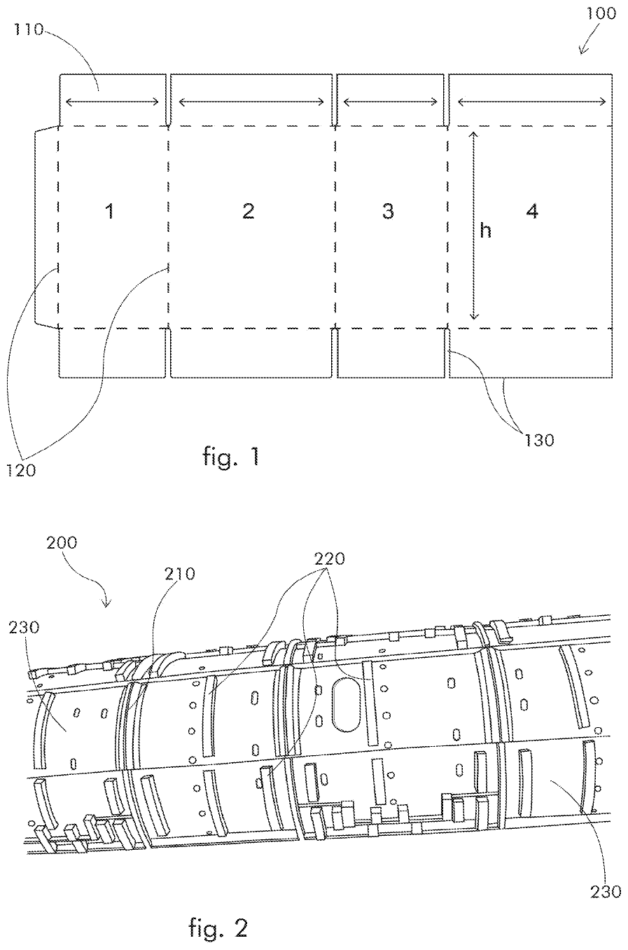

Referring to the example of known box in FIG. 1, in the case of an embodiment of the magnetic modular cutting die according to the invention, the same box will be manufactured instead by assembling magnetic parts already arranged on the metal cylinder.

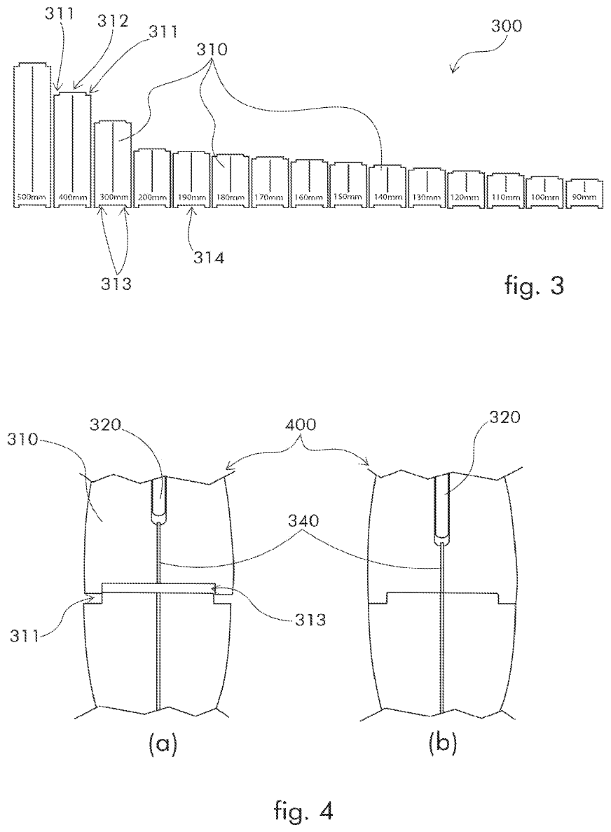

The modular assembly elements are shown, according to an embodiment, in FIG. 3. In this embodiment, the set 300 of modular elements 310 is a set of elements of the same shape but different size.

The shape of the single element 310 is substantially rectangular, with a curvature in the direction perpendicular to the sheet. More generally, the single module 350 has a perimeter comprising two first opposite sides transverse to said extension direction and two second opposite sides parallel to an extension direction.

In more detail, each element 310 has two ends (or in general first end sides) along a main direction (vertical in the drawing, this is an extension direction along an arc of a circle). At one end, each element has a recess 314 and at the other end a tooth 312 (or first shape coupling means positioned on one of said first end sides) sized to enter into the notch or recess 314 (corresponding second shape coupling means positioned on an opposite side of said first end sides), so as to cover an arc of a circle on the metal cylinder. Indeed, one of the two surfaces of each element (surfaces in the direction perpendicular to the main direction) is magnetic and is intended to adhere to the metal cylinder (having an axial direction perpendicular to said extension direction). Here, the magnetic surface is also referred to as a “connection surface”, included in said perimeter. The surface opposite to the connection surface is the so-called “die surface”, comprising the elements described below.

In detail, the tooth 312 (e.g., central on the side from which it protrudes) is obtained by eliminating the corners 311 of the rectangle, and the notch or recess 314 constructionally has side protrusions 313. There can also be multiple teeth and multiple recesses, in any embodiment, e.g., two teeth and two recesses, in particular at the ends of the sides perpendicular to said extension direction.

In all embodiments, the cutting die modules can have a different length in said extension direction along an arc of a circle.

FIG. 4 shows the association of two elements like those just described: in (a) they are just spaced apart, while in (b) the two elements are joined (thus achieving shape coupling by said first and second shape coupling means). The above-mentioned curvature is observed. The element 320 is one of the cutting/folding/feeding elements mentioned above with reference to FIG. 2. The element 340 is specifically a folding element, shown as an example.

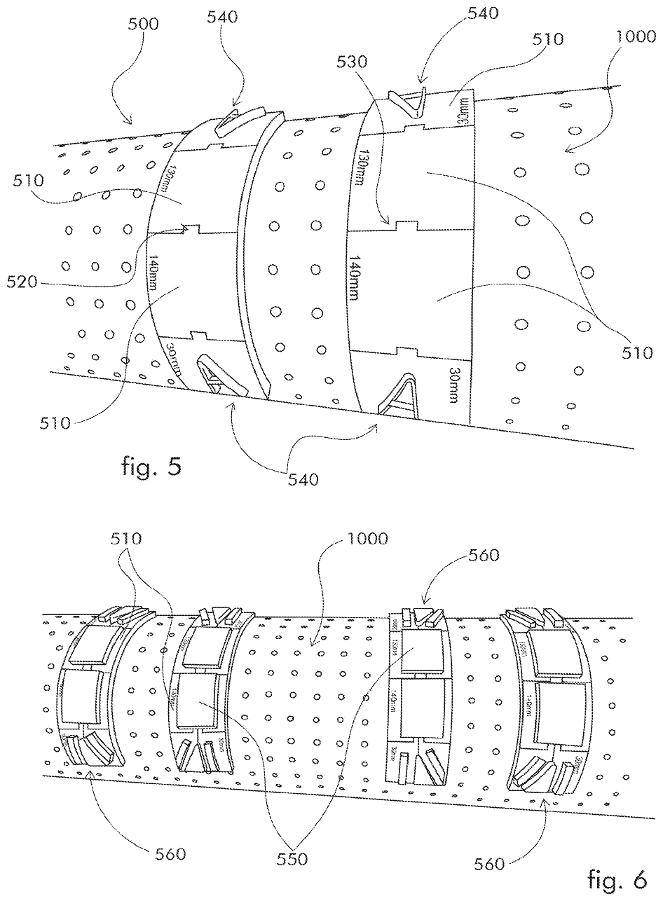

FIG. 5 shows a partial assembly of a cutting die according to the invention. Here, the modules 510 are slightly different in that the recess 530 and the tooth 520 are much narrower, but the concept is similar. Moreover, according to the invention, other shapes dedicated to the coupling of various modules are possible. Two similar strips are assembled on the cylinder 1000 in the figure. The elements 540 are cutting elements appropriately fixed on the modules (they can be considered part of the modules).

FIG. 6 shows four strips assembled on the cylinder 1000, with cutting elements 560 on some of the modules 510 and feeding elements 550. The cylinder 1000 is perforated but it is not a necessary condition, precisely because the magnetic coupling makes screw means unnecessary for fixing the cutting die elements. In general, and for all embodiments, each cutting die module has “cutting die elements” that can be cutting and/or feeding and/or folding elements. A subset of the cutting die elements can also comprise only one type of the mentioned elements, in particular only feeding elements.

Advantageously according to the invention, the magnets of the modules have an adequate magnetic force to withstand the stresses generated during the use of the cutting die. Each module must withstand the stresses and remain in the assigned position. Below is a table with exemplary intervals:

TABLE 1

| | |
|---|---|
| General description | Flexible magnetic profile |
| | obtained by calendering process |
| Material | Isotropic plastoneodymium |
| | composed of NdFeB and plastic |
| | binder, with multipolar |
| | magnetization and acrylic |
| | adhesive 3M9448 |
| Dimensions | Section mm 20 × 1.5 |
| Magnetic | Br 0.48-0.58 T/HcB 290-380 |
| characteristics | kA/m/HcJ 630-800 kA/m |
| | (BH)max 44-52 kJ/m³ |
| | Temp. coefficient Br: −0.11%/° C. |
| | Nominal attraction force: 600 |
| | g/cm², preferably in the range |
| | of 500-700 |
| Technical features | Operating temperature: from −40° C. |
| | to 120° C. |
| | Density: 4.65-5.25 g/cm³ |
| | Hardness: >30 Shore D |
| | Magnetization: multipolar on |
| | one face, polar pitch 5 mm |
| Packaging | Available in 1-5-10 m rolls or |
| | cut to size |
| Certifications | Material complying with |
| | Directive 2002/95/EC - RoHS and |
| | legislation |

It is apparent that a high magnetic force makes it difficult to detach the module for assembling a new cutting die. For this purpose, on the edge of each module (or on a portion of the edge), a few millimeters (e.g., 6-7) of material are removed from the side of adhesion to the metal cylinder so as to fit an appropriate lever into this void between the module and the metal cylinder.

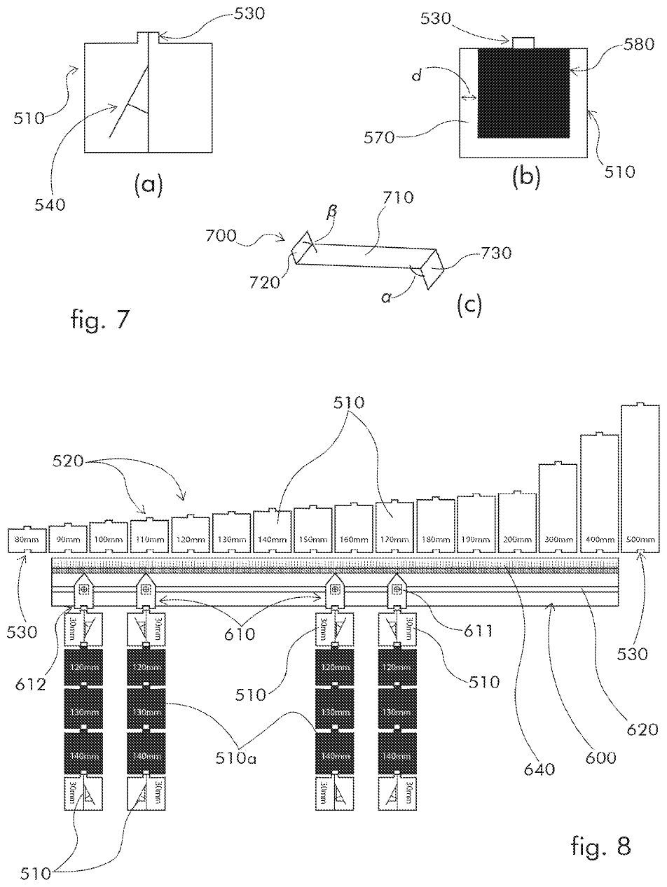

An example of this lever is given in FIG. 7, diagrammatically showing (a) a top view of the module 510 above, with the tooth 530 and the cutting blade 540, and (b) a bottom view of the same module 510, where the partially peripheral empty space 570 is highlighted, while the module magnet 580 is in the middle (in general and for all embodiments, it extends over at least one portion from the connection surface). The space 570 can be partially peripheral or even totally peripheral, i.e., it can run all around the magnet 580, which for convenience is shown square in shape, but can have other shapes. In the space or region 570, the thickness of the cutting die module in the direction perpendicular to the extension direction is preferably less than the thickness of the cutting die module where said module magnet 580 is present.

The module magnet 580 is chosen with a magnetization constant such that it applies a nominal attraction force between 500 and 700 g/cm², more preferably between 550 and 650 g/cm2, so that it can withstand the cylinder rotation even better.

The distance d is the distance between the edge of the module 510 and the beginning of the magnet, on one or more sides where the magnet is not flush with such an edge. One of the two angled ends 720 and 730 of the lever 700 shown in figure (c), precisely configured to insert and lift the cutting die module with respect to the metal cylinder, is fitted into space 570. Preferably, the lever 700 (shown in the figure without thickness for simplicity) comprises a central body 710, with respect to which the end 720 forms an angle fi and the end 730 forms an angle α. Preferably, at least one of the two angles is between 100° and 120°, even more preferably of about 110°, which angles ensure high practicality of use.

Below are some composition examples of cutting dies that can be made by means of the modular system of the invention:
Size 1385×400×300 (two cleavers with 55 mm creases+190 mm crease);
Size 1385×400×400 (two cleavers with 55 mm creases+190 mm crease+100 mm crease);
Size 1385×400×500 (FIG. 13-two cleavers with 55 mm creases+190 mm crease+200 mm crease);
Size 980×550×110 (two cleavers with 55 mm creases);
Size 985×545×400 (two cleavers with 55 mm creases+190 mm crease+100 mm crease);
Size 1195×785×665 (two cleavers with 55 mm creases+150 mm crease+300 mm crease+100 mm crease); and
Size 1200×800×1200 (without upper flaps, one 55 mm cleaver+500 mm crease+300 mm crease+200 mm crease+150 mm crease).

### Off-Machine Assembly System

With reference to FIG. 8, an off-machine assembly system for magnetic modular cutting dies is described.

The system is developed about a concept of off-machine arrangement of the axial extension size required for the box.

Once the axial size has been set up on a supplied millimeter bar 600 made of aluminum or other material (in this application “millimeter bar” means any graduated scale extending in a linear direction, for example, and allows measuring a distance), the bar 600 itself is placed in the machine with a magnetic coupling (by means of a “bar magnet”, not shown), and the modular cutting die is composed by means of the magnetic coupling system.

For example, the cutting die is configured with:
upper cutting module (4 pieces);
lower cutting module (4 pieces); and
spacer modules 510a that can be provided with creases or rubber for feeding the box only, or can be plain.

The concept is the off-machine arrangement (axial size) and quick assembly system of the magnetic modular cutting die.

In general, the graduated bar comprises:
a first bar surface including a bar magnet configured to connect the bar 600 to said metal cylinder 1000 with said linear direction parallel to said axial direction;
a second bar surface opposite to said first bar surface along a direction perpendicular to said linear direction;
on said second bar surface, a linear guide 620 running in said linear direction.

As shown, one slider 610 for each module strip can slide in the linear guide 620. The slider 610 has fixing means 611 allowing the slider itself to be clamped at a given height of the guide 620. After the off-machine arrangement, the bar (with millimeter scale 640) is thus placed at the metal cylinder 1000 and the modules 510 are adhered to the cylinder. The sliders 610 are then disengaged and the bar removed.

Note that the slider 610 has a recess 612 for the connection with the cutting die modules 510 (or 310 in the embodiment described above). There can be a protrusion or tooth instead of the recess, the cutting die modules being capable of being positioned with a corresponding recess; any shape coupling is possible between slider and modules and between module and module, according to the invention.

As with the cutting die modules, the graduated bar 600 can also have a magnet-free region along at least one portion of the perimeter thereof, for the insertion of a lever dedicated to removing the graduated bar itself.

Similar to the cutting die modules, the bar magnet can be chosen with a magnetization constant such that it applies a nominal attraction force between 500 and 700 g/cm², preferably between 550 and 650 g/cm² so as to ensure an adequate adhesion against external stresses.

As seen from the figures, by virtue of the system of the invention (step A) it is possible to manufacture a cutting die by arranging one or more cutting die modules 310; 510 on said metal cylinder 1000 with the corresponding module magnet 580 in contact with the metal cylinder 1000.

Such an arrangement step B can comprise the following sub-steps:
B1. arranging one or more cutting die modules 310; 510 in correspondence of said graduated bar 600 with shape coupling with said at least one positioning element 610 and with one another along said extension direction;
B2. magnetically fixing said graduated bar 600 to said metal cylinder 1000;
B3. magnetically fixing said one or more cutting die modules 310; 510 to said metal cylinder 1000;
B4. releasing said at least one positioning element 610 from said one or more cutting die modules 310; 510; and
B5. removing said graduated bar 600 from said metal cylinder 1000.

Moreover, step B can comprise the following preliminary step:
B0. removing, by means of the aforesaid lever, at least one cutting die module 310; 510 previously magnetically fixed to said metal cylinder 1000.

The lever can also be used in step B5.

### Advantages of the Invention

The system according to the invention is advantageous for various box models. For each box model, the system is universal, i.e., it becomes a durable good, no longer manufactured for a specific order.

The manufacturer of a box, with the modular system according to the invention, does not need to order a special cutting die but already has the system in-house to manufacture it.

This results in a significant improvement for the user such as:
less storage space (manufacturers usually have 5/6/700 pieces manufactured per year to be stored in organized spaces for individual cutting dies);
increased service to the end customer (time for making the cutting die by the supplier eliminated—3-4 days);
elimination of the administrative process related to cutting die orders, etc.; and
elimination of the cutting die disposal process at the end of life.

In the above disclosure, preferred embodiments were described and some variants of the present invention were suggested, but it is understood that those skilled in the art may make modifications and changes without departing from the related scope of protection, as defined by the appended claims.

1. A modular system for creating a cutting die, comprising:
a set of cutting die modules, each cutting die module having:
an extension direction along an arc of a circle;
a perimeter comprising two first opposite sides transverse to said extension direction and two second opposite sides parallel to said extension direction;
a connection surface comprised in said perimeter, the connection surface being configured to be positioned on a metal cylinder that extends in an axial direction, with said extension direction perpendicular to said axial direction;
a die surface comprised within said perimeter and opposite to said connection surface, said die surface comprising at least one die or feeding element;
wherein:
said connection surface comprises a module magnet, which extends over at least one portion from the connection surface; and
each cutting die module comprises first shape coupling means on one of said two first opposite sides and corresponding second shape coupling means on the other of said two first opposite sides, so that two different cutting die modules can achieve a shape coupling by said first and second shape coupling means.

2. The modular system of claim 1, wherein said module magnet extends over said connection surface to leave a space in a region along at least one portion of said perimeter, in said region a thickness of the cutting die module in a direction perpendicular to the extension direction being less than the thickness of the cutting die module in which said module magnet is present.

3. The modular system of claim 1, wherein said module magnet has a magnetization constant configured to apply a nominal attraction force comprised between 500 and 700 g/cm².

4. The modular system of claim 3, wherein said nominal attraction force is comprised between 550 and 650 g/cm².

5. The modular system of claim 2, further comprising a lever configured to fit into said space and lift said cutting die module relative to said metal cylinder.

6. The modular system of claim 1, wherein a subset of said set of cutting die modules consists of modules, wherein said opposite in which the die surface has only feeding elements.

7. The modular system of claim 1, wherein said set of cutting die modules comprises at least one subset having modules of different lengths in said extension direction along a circumferential arc.

8. The modular system of claim 1, wherein said first shape coupling means comprise at least one tooth protruding from one of said two first opposite sides and said second shape coupling means comprise at least one corresponding recess on the other of said two first opposite sides.

9. The modular system of claim 1, wherein there is only one tooth and one recess, and said tooth and said recess are central to said two first opposite sides.

10. The modular system of claim 8, wherein there are two teeth and two recesses, the two teeth and the two recesses being at ends, perpendicular to said extension direction, of corresponding first sides.

11. The modular system of claim 1, wherein:
the modular system further comprises a graduated bar that extends in a linear direction and comprises:
a first bar surface comprising a bar magnet configured to connect the graduated bar to said metallic cylinder with said linear direction parallel to said axial direction;
a second bar surface opposite to said first bar surface along a direction perpendicular to said linear direction;
a guide running in said linear direction on said second bar surface; and wherein
the modular system further comprises at least one positioning element:
configured to slide along said guide;
provided with fixing means at a predetermined position of said guide; and
provided with at least one recess or tooth for a shape coupling with said at least one tooth or recess of the cutting die module.

12. The modular system of claim 11, wherein said bar magnet has a constant magnetization configured to apply a nominal attraction force comprised between 500 and 700 g/cm².

13. The modular system of claim 12, wherein said nominal attraction force is comprised between 550 and 650 g/cm².

14. The modular system of claim 11, wherein said bar magnet extends over said first bar surface to leave a space in a region along at least one portion of the perimeter of said first bar surface, in said region a thickness of the graduated bar in the direction perpendicular to the linear direction being less than the thickness of the graduated bar where said bar magnet is present.

15. A method for manufacturing a cutting die, the method comprising:
A) providing a modular system for creating a cutting die comprising:
a set of die modules, each die module having:
an extension direction along an arc of a circle;
a perimeter comprising two first opposite sides transverse to said extension direction and two second opposite sides parallel to said extension direction;
a connection surface comprised in said perimeter, the connection surface being configured to be positioned on a metal cylinder that extends in an axial direction, with said extension direction perpendicular to said axial direction;
a cutting die surface comprised within said perimeter and opposite to said connection surface, said cutting die surface comprising at least one die or feeding element;
wherein:
said connection surface comprises a module magnet, which extends over at least one portion from the connection surface; and
each cutting die module comprises first shape coupling means on one of said two first opposite sides and corresponding second shape coupling means on the other of said two first opposite sides, so that two different cutting die modules achieve a shape coupling by said first and second shape coupling means;
the modular system further comprising a lever configured to fit into said space and lift said cutting die module relative to said metal cylinder, wherein:
the modular system further comprises a graduated bar that extends in a linear direction and comprises:
a first bar surface comprising a bar magnet configured to connect the graduated bar to said metallic cylinder with said linear direction parallel to said axial direction;
a second bar surface opposite to said first bar surface along a direction perpendicular to said linear direction;
a guide running in said linear direction on said second bar surface; and wherein
the modular system further comprises at least one positioning element:
configured to slide along said guide;
provided with fixing means at a predetermined position of said guide; and
provided with at least one recess or tooth for a shape coupling with said at least one tooth or recess of the cutting die module; and
B) arranging one or more cutting die modules on said metal cylinder with a corresponding module magnet in contact with the metal cylinder.

16. The method of claim 15, wherein step B) comprises the following substeps:
B1) arranging one or more cutting die modules at said graduated bar with a shape coupling with said at least one positioning element and with each other along said extension direction;
B2) magnetically fixing said graduated bar to said metal cylinder;
B3) magnetically fixing said one or more cutting die modules to said metal cylinder;
B4) releasing said at least one positioning element from said one or more cutting die modules; and
B5) removing said graduated bar from said metal cylinder.

17. The method of claim 15, wherein step B) comprises the following preliminary step:
B0) removing, by said lever, at least one cutting die module previously magnetically fixed to said metal cylinder.

18. The method of claim 15, wherein step B5) comprises using said lever.
